(19) United States
(12) Patent Application Publication
(10) Pub. No.: US 2008/0317394 A1
(43) Pub. Date: Dec. 25, 2008

(54) Bearing Arrangement

(76) Inventors: Arnold Blanke, Damme (DE); Dirk Maehlmann, Vechta (DE); Thomas Roesler, Osnabrueck (DE); Uwe Schmidt, Stemwede (DE)

Correspondence Address: MCGLEW & TUTTLE, PC, P.O. BOX 9227, SCARBOROUGH STATION, SCARBOROUGH, NY, 10510-9227, US

(21) Appl. No.: 11/572,452

(22) PCT Filed: Jul. 13, 2005
(86) PCT No.: PCT/DE2005/001238

§ 371 Date: Sep. 10, 2008

(30) Foreign Application Priority Data
Jul. 20, 2004 (DE) 10 2004 035 073.6

(51) Int. Cl. F16C 33/74

(52) U.S. Cl. 384/138

(57) ABSTRACT

A bearing arrangement (4) is provided with a bearing inner bush (10) and an outer bush (5), especially for the central joint (1) of a Watt's linkage. The bearing arrangement (4) is provided with a sealing arrangement (12) surrounding the front-side bearing gap between the inner bush (10) and the outer bush (5). The sealing arrangement (12) comprises an elastic sealing element (14) with static as well as dynamic sealing surfaces. The bearing arrangement (4) has a sealing arrangement (12) designed as a sealing module (12), which can be connected to the bearing inner bush (10), the sealing module (12) also comprising a running surface (15) for the axial bearing of the outer bush (5). The arrangement makes possible the especially economical production of modularly designed, highly loadable bush bearings. Furthermore, undivided, continuous bearing bushes can be used, which improves the ability to be mounted and the precision and the service life of the bearing arrangement. It is also possible, especially in case of highly stressed bush bearings, to dimension the axial rigidity as well as the radial rigidity of the bearing arrangement independently from one another, and especially good sealing is obtained against environmental effects.

### CROSS REFERENCE TO RELATED APPLICATIONS

This application is a United States National Phase application of International Application PCT/DE2005/001238 and claims the benefit of priority under 35 U.S.C. § 119 of German Patent Application DE 10 2004 035 073.6 filed Jul. 20, 2004, the entire contents of which are incorporated herein by reference.

### FIELD OF THE INVENTION

The present invention pertains to a bearing arrangement, especially for the central joint of a Watt's linkage.

### BACKGROUND OF THE INVENTION

Bearing arrangements of this class are used, for example, but by no means exclusively, as central joints in Watt's linkages. Watt's linkages are used especially in rear axles of high-quality motor vehicles. The Watt's linkage connects the wheel suspensions of the two rear wheels to one another as well as to the chassis and the vehicle body such that spring compression of one or both rear wheels is possible without hindrance, whereas lateral motions of the rear axle or the real wheels in relation to the chassis and, in other modes of construction of the Watt's linkage, also rolling motions of the body are prevented from occurring or are reduced.

Bearing arrangements on the motor vehicle, especially bearing arrangements for such central joints, are subject to permanent load by forces and torques because of the dynamic loads occurring during the travel of the motor vehicle, for example, as a consequence of the centrifugal acceleration during travel in curves or as a consequence of highly dynamic spring compression motions in case of unevennesses of the pavement. Since such aspects as cost-saving lightweight construction and the reduction of the amount of space needed for installation on the motor vehicle are of ever increasing significance, increasing attention is paid to size reduction and integrated modular design in the case of such bearing arrangements as well, as a result of which the already high requirements imposed on such bearing arrangements are additionally increased.

A plain bearing for chassis parts with an inner bush and an outer bush, in which both bearing bushes have axial bearing surfaces at an axially outer end, is known from DE 40 36 050 C1. The inner bush has a radial flange projection, which extends on one side at the axial end of the inner bush and is in turn supported via a sliding surface on the axial front side of the outer bush. The plain bearing known from this document comprises, for protection against environmental effects, a seal, which is made in one piece with a rubber body surrounding the entire bearing and surrounds the two flange projections of the bearing bushes, which said flange projections are in contact with one another.

However, this prior-art plain bearing is, on the one hand, inevitably asymmetrical or in the form of two halves and it must therefore be installed, in general, in an arrangement that is mirror-inverted in pairs. However, an axial clearance develops now, in principle, which must again be compensated by corresponding measures.

This is linked in this prior-art plain bearing especially with the fact that the axial bearing surfaces are formed by radial flange projections made in one piece with the corresponding bushes, which is why the bearing bushes can be mounted in a corresponding bearing opening from one side only. In addition, the one-piece design of the seal with the rubber body surrounding the bearing makes difficult, on the one hand, the deformation-free mounting especially of the seal and makes it, moreover, impossible to perform maintenance or optionally to replace the seal later without having to remove the entire bearing. Furthermore, additional separate components, for example, sliding rings, are necessary to embody the axial mounting in such prior-art plain bearings. Finally, this prior-art plain bearing has, due to its construction, both a high axial elasticity as well as a high radial elasticity, which is, however, undesirable for certain applications of plain bearings. The sealing against environmental effects also often fails to meet high requirements in such prior-art bearing arrangements.

### SUMMARY OF THE INVENTION

Against this background, the object of the present invention is to create a bearing arrangement, which overcomes the drawbacks of the state of the art. In particular, the need to split the bearing arrangement into two parts and the problems associated therewith in terms of axial clearance shall be eliminated. Furthermore, the construction of the bearing arrangement shall make possible modular manufacture as well as assembly and lower production, assembly and maintenance costs associated therewith. Finally, the bearing arrangement shall have the smallest possible tolerances, excellent tightness, high axial rigidity and optionally also radial rigidity as well as high loadability and service life.

The bearing arrangement according to the present invention has, in a manner at first known per se, an inner bush and an outer bush, the inner bush and the outer bush being rotatingly movable relative to one another along a bearing surface common to both bushes. The inner bush may also be, in principle, a massive bearing bolt, but a hollow inner bush is combined, in general, with an additional fastening bolt under the conditions of use in question, especially in case of use of the bearing arrangement in a Watt's linkage.

In a manner that is likewise known per se, the bearing arrangement has, furthermore, at least one sealing arrangement, which surrounds the front-side bearing gap between the inner bush and the outer bush and which seals the bearing gap from the environment. The sealing arrangement comprises an elastic sealing element with static as well as dynamic sealing surfaces. This means that the sealing arrangement or the elastic sealing element of the sealing arrangement is statically in contact especially in the area of one of the two bearing bushes, while the sealing element forms a sliding seal in the area in which it is in contact with the other bearing bush.

However, the bearing arrangement is characterized according to the present invention in that the sealing arrangement is designed as a sealing module that can be connected to the inner bush. The sealing module also comprises a running surface means for the axial mounting of the outer bush relative to the inner bush.

In other words, this means at first that the functionality of the axial mounting is added according to the present invention to the modular sealing arrangement, which can be connected to the inner bush, and consequently it no longer relies upon a radial flange projection connected in one piece to the inner bush, as this is usually the case in the state of the art. Both the outer bush and the inner bush can thus have an essentially cylindrical design, and the entire bearing can therefore also be installed in the bearing opening from one side, without splitting the bearing bushes into halves being necessary.

Furthermore, the combination of the sealing arrangement and the running surface means makes possible the completely modular design of the bearing arrangement as well as of the sealing thereof. In particular, the complete sealing arrangement, which is a separate component, including the axial bearing, can thus be manufactured with high precision, mounted and optionally replaced as a module. Thus, it is also no longer necessary to remove the complete bearing to replace the sealing arrangement, as this is usually the case in the state of the art.

Moreover, the desired axial rigidity or axial precision of the bearing can be set and provided for by the design as desired based on the functional separation of the sealing and the axial bearing, which is performed in the bearing arrangement according to the present invention. Especially high axial rigidity or bearing precision can thus be achieved, and, moreover, they can be set independently from the radial flexibility of the bearing arrangement, which may be present. Especially good sealing is also achieved as a result against foreign media and environmental effects.

Finally, the functional separation of the sealing and thrust bearing makes possible the mounting of the sealing independently from the mounting of the bearing bushes, especially also after the mounting or the assembly of the outer bush of the bearing with adjoining components, which reduces the mounting-related load on the seal and reduces the risk of mounting errors with a reduction of the service life of the bearing, which is associated therewith.

For the use of the bearing arrangement in a Watt's linkage, the design according to the present invention leads to an exact, but smooth-running response behavior of the central joint and of the Watt's linkage and thus contributes to the improvement of driving smoothness as well as driving safety.

The specific design and the materials used for the bearing arrangement according to the present invention, especially for the sealing module, are not even essential for the present invention at first as long as the intended service lice of the bearing or the seal can be complied with. According to a preferred embodiment of the present invention, the sealing module does, however, comprise a carrying element, and the running surface means and the carrying element consist of different materials. In other words, this means that especially the running surface means can be manufactured from a material that is optimized in terms of sliding properties and wear resistance.

Moreover, how the static and dynamic sealing surfaces of the sealing module are shaped or arranged is not essential for the present invention as long as the bearing gap is protected in accordance with the requirements. Thus, it is conceivable, for example, that separate components, which are each connected to the carrying element of the sealing module, are present for static and dynamic sealing surfaces. According to a preferred embodiment of the present invention, the elastic sealing element is, however, a one-piece element, which means that static and dynamic sealing surfaces are arranged on one and the same elastic sealing element. The static seal preferably comprises an annular sealing collar arranged between the sealing module and the bearing block.

The manner of connection between the running surface means and the sealing module or the carrying element of the sealing module is likewise not essential for the present invention. However, according to another, likewise preferred embodiment of the present invention, the running surface means reaches behind or passes through the carrying element in a positive-locking manner. This is especially advantageous when using an especially wear-resistant polymer material with especially low coefficient of sliding friction, which experience has shown to be able to be connected or bonded to other materials only poorly, for the running surface means. The fact that the running surface means reaches behind or passes through the carrying element in a positive-locking manner ensures in this case that the running surface means cannot separate from the carrying element or cannot perform uncontrolled relative motions even if the material of the running surface means does not adhere to the material of the carrying element.

The connection between the sealing module, on the one hand, and the carrying element and the inner bush of the bearing arrangement, on the other hand, can likewise be embodied according to the present invention as desired, as long as the forces necessary for the particular bearing, especially axial forces, can be transmitted. However, according to a preferred embodiment of the present invention, the sealing module and the carrying element of the sealing module is shrunk or pressed onto the axial end of the inner bush. The shrinking-on or pressing-on may take place, for example, in the area of a collar or radial shoulder in the end area of the inner bush of the bearing. A rigid connection is thus achieved between the bearing bush and the sealing module or the carrying element, but this connection can be manufactured efficiently and therefore at a low cost.

According to another, likewise preferred embodiment of the present invention, the outer bush comprises a support ring, which has an axial stop plane. The support ring is preferably shrunk or pressed on the outer bush and is used especially as a stop plane or stop surface for the dynamic sealing surface of the sealing module.

According to an especially preferred embodiment, both the dynamic sealing surface of the sealing module and the sliding surface of the running surface means come into contact with the stop surface or in one and the same stop plane of the support ring. This is advantageous, because the support ring thus assumes a simple shape. Thus, the support ring needs to have only a single stop plane, which can be manufactured in a simple manner and at low cost, and which can, nevertheless, be readily manufactured with high quality and extremely high precision because of its simple shape and arrangement.

However, according to an alternative embodiment of the present invention, the dynamic sealing surface may also have a stop surface of its own in the area of the support ring or directly at the outer bush. The dynamic seal, fully surrounding the front side of the outer bush, can come for this purpose into contact especially with an outer circumference of the outer bush. Not only is this embodiment especially compact, but it also permits preassembly of the bearing arrangement from the inner bush, the outer bush and the sealing module, in which case the bearing components thus preassembled are preliminarily held together because of the bellows-like, elastic sealing element surrounding the bearing bushes.

The design and the material of the bearing surfaces of the inner bush and the outer bush, which slide on one another, are likewise not essential for the present invention. Thus, the inner bush and the outer bush may come, for example, directly into contact with one another or slide on one another, for example, along a cylindrical bearing surface. According to a preferred embodiment of the present invention, the bearing surface is formed, however, by an additional bearing element made of polymer on the side of the inner bush. The bearing element is especially preferably in the form of an extrusion-coated plastic on the inner bush, especially one made of a thermoplastic polyurethane.

Thermoplastic polyurethanes are advantageous because of their special material properties. Thermoplastic polyurethanes are characterized especially by high toughness with a certain flexibility as well as by extremely high abrasion resistance and good vibration damping capacity with good resistance to media at the same time.

According to another preferred embodiment of the present invention, the plastic bearing element comprises at least one additional dynamic seal for protecting the bearing surface between the inner bush and the outer bush. This additional dynamic seal may be, for example, in the form of annular sealing lips, which extend in the area of the axially outer ends of the bearing arrangement between the surfaces of the inner bush and the outer bush.

According to another preferred embodiment of the present invention, the static seal may comprise a circumferential joint arranged axially between the bearing element and the sealing module or the carrying element. This static circumferential joint prevents contaminants that are possibly present in or have penetrated into the area of the pressed connection between the carrying element and the inner bush from being able to be pushed forward into the area of the bearing surface between the inner bush and the outer bush.

According to another, especially preferred embodiment of the present invention, the sealing module comprises an additional splash guard preferably in the radially outer area of the sealing module or the elastic sealing element. This additional splash guard may be designed especially as a contactless sealing gap or in the manner of a labyrinth seal and thus forms a first barrier to dirt, moisture and other potentially harmful environmental media. In addition, the additional splash guard also shields the abrading dynamic sealing surface of the sealing module, for example, against the water jet of the high-pressure cleaners commonly used nowadays. The additional splash guard is preferably made in one piece with the elastic sealing element.

The material of the elastic sealing element can be selected, in principle, as desired, as long as the necessary sealing properties and requirements in terms of service life are met. However, the elastic sealing element especially preferably consists of nitrile-butadiene rubber, which has proved to the especially well suited for such sealing purposes because of its resistance to a great variety of media as well as because of its advantageous mechanical properties.

On the whole, it is not necessary for embodying the present invention for the bearing arrangement to have a symmetrical design and/or for the two ends of the inner bush and the outer bush to have an identical design and the same sealing module, because asymmetrical and only one-sided bearing arrangements are, in principle, also conceivable and can be used. However, especially if the bearing arrangement is used for a Watt's linkage, provisions are preferably made for the bearing arrangement to have a sealing module and/or a support ring each at both axial ends. Based on the fact that the modular design of the bearing arrangement is possible thanks to the present invention, it is possible now, in particular, to arrange identical sealing modules or support rings at both ends of the bearing.

The present invention will be explained in greater detail below on the basis of examples intended as exemplary embodiments only. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view of a central joint for a Watt's linkage of a motor vehicle axle;

FIG. 2 is a schematic sectional view of the central joint according to FIG. 1 with a first embodiment of a bearing arrangement according to the present invention in a sectional view through the joint axis;

FIG. 3 is a cut-away sectional view of an enlarged detail from FIG. 2 according to mark “A” in FIG. 2;

FIG. 4 is the detail according to FIG. 3 in another section plane in a view corresponding to FIG. 3;

FIG. 5 is a schematic sectional view of a central joint according to FIG. 1 with another embodiment of a bearing arrangement according to the present invention;

FIG. 6 is an enlarged detail from FIG. 5 according to mark “B” in FIG. 5 in a view corresponding to FIGS. 3 and 4; and

FIG. 7 shows the detail according to FIG. 6 in another section plane in a view corresponding to FIGS. 3, 4 and 6.

### DESCRIPTION OF THE PREFERRED EMBODIMENTS

Referring to the drawings in particular, FIG. 1 shows first the assembly of a central joint 1 for a Watt's linkage of a motor vehicle axle in a schematic view.

Two sheet metal components 2, 3, which form the housing and the bearing block of the central joint 1, respectively, are recognized at first. The rocker or coupler 6 of the Watt's linkage, which is visible in FIG. 1 only partially, is connected to a rotatable outer bush 5 of a bearing arrangement 4, which is located behind the coupler 6 in the view according to FIG. 1 sand is therefore hidden. The two sleeve joints 7 of the coupler 6, of which only a sleeve joint 7 is visible partially in FIG. 1, are used to articulate and kinematically couple the pushing struts of the Watt's linkage (which are not shown here).

It becomes recognizable from FIG. 1 that the central joint 1 has an extremely compact and hence space-saving and lightweight design, which does, however, lead to even stronger forces and torques in the area of the bushes and the bearing 4 of the central joint 1 because of the short lever arms of the coupler 6.

All components of the central joint 1, especially the bearing 4, must therefore meet the highest requirements concerning loadability, fail-safe operation and service life, especially because the Watt's linkage represents an assembly unit that is elementary for the directional stability of the motor vehicle, whose failure can substantially compromise the controllability of the vehicle and must therefore be avoided under any circumstances in the case of the basic application of this embodiment of the bearing arrangement according to the present invention.

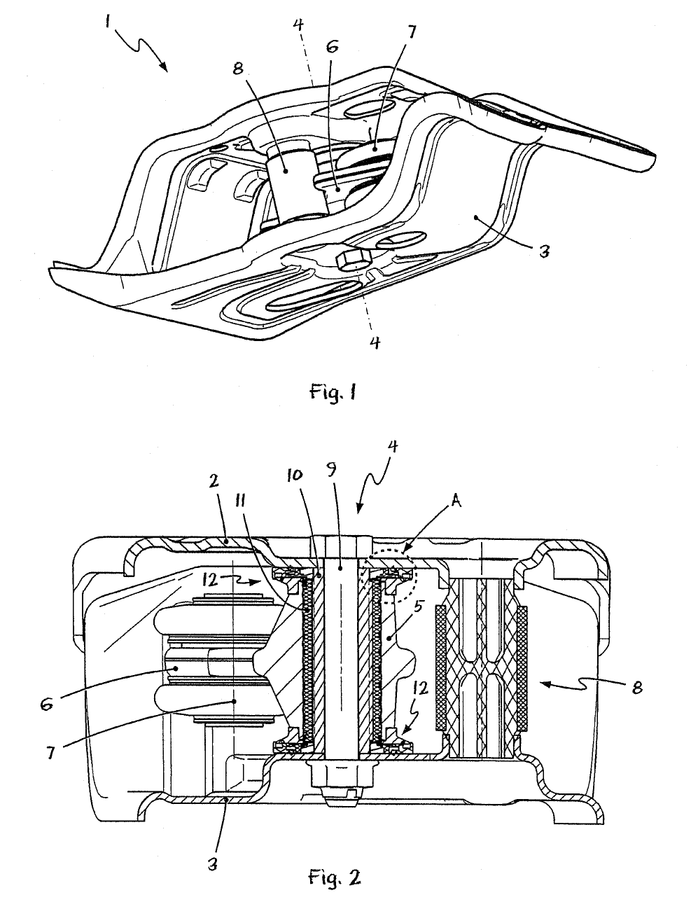

FIG. 2 shows the central joint according to FIG. 1 in a sectional view through the joint axis. The housing components and bearing blocks 2, 3 are again recognized at first. Furthermore, the shape of the bearing 4 of the central joint 1 with the outer bush 5 carrying the coupler 6 as well as of the stop buffer 8 for liming the rotary motion of the bearing 4 or of the coupler 6 can be recognized from FIG. 2. One of the two sleeve joints 7, which is arranged on the coupler 6 and is located behind the section plane in FIG. 2, can be recognized as well.

The bearing 4 of the coupler 6 of the Watt's linkage comprises essentially the inner bush 10, which is fastened rigidly in the housing and in the bearing blocks (bearing connection parts) 2, 3 by means of the bolt 9 in such a way that it rotates in unison, the outer bush 5 carrying the coupler 6 as well as an additional bearing element 11 made of plastic, which is arranged between the inner bush 10 and the outer bush 5. Furthermore, the bearing has, at both axial bearing ends, a sealing arrangement or a sealing module 12 each.

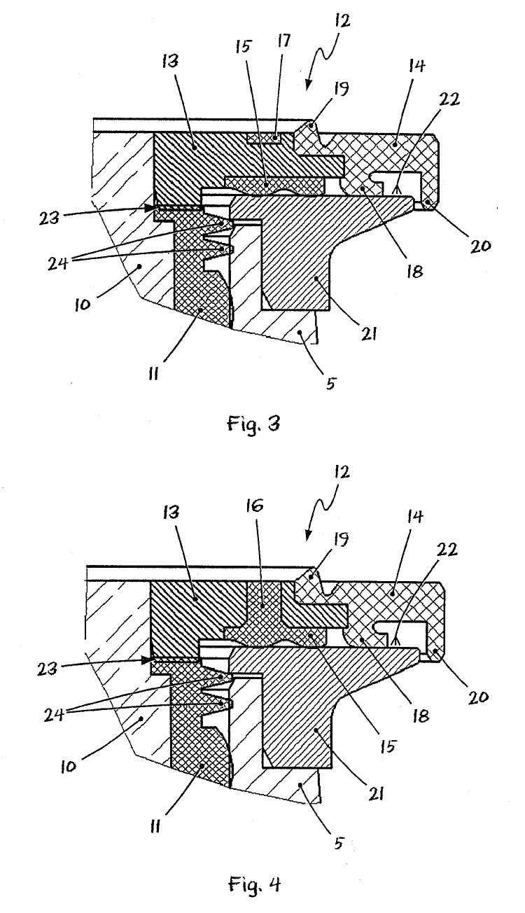

The more specific design of the sealing arrangement or of the sealing module 12 appears from FIG. 3 as well as FIG. 4. The enlarged detail shown in FIG. 3 and FIG. 4 corresponds to the area designated by letter “A” in FIG. 2. The inner bush 10, which is visible only partially because of the cut-away sectional view, as well as the outer bush 5 of the bearing 4, which said outer bush is likewise visible only partially for the same reason, are recognized at first. In the exemplary embodiment shown, the surfaces of the inner bush 10 and the outer bush 5 do not slide directly on one another. The inner bush 10, which may also be manufactured, for example, from aluminum for this purpose, is rather extrusion-coated with an additional bearing element 11 consisting of thermoplastic polyurethane, on the radially outer surface of which the outer bush is mounted rotatably.

Furthermore, the sealing arrangement or the sealing module 12 of the bearing arrangement 4 according to the present invention is recognized from FIG. 3 and FIG. 4. The sealing module 12 comprises the annular carrying element 13, the elastic sealing element 14 as well as running surface means 15, 16, 17 or the running surface 15. It is recognized that the carrying element 13 is pressed onto the inner bush 10 in the area of a cylindrical shoulder, and that both the running surface 15 and the elastic sealing element 14 are each designed in the form of an extrusion coating of the carrying element 14 with a corresponding polymer material. The extrusion coating 15, 16, 17 forming the running surface 15 passes through the carrying element 13 in a row of axial recesses 16, which appears from a comparison of FIG. 3 and FIG. 4. FIG. 3 and FIG. 4 differ only in the angle of the section plane through the axis of the central joint 1 and the bearing arrangement 4.

To guarantee reliable positive-locking connection between the running surface 15 and the carrying element 13, the extrusion-coated recesses 16 are also in connection on the rear side of the carrying element 13 located opposite the running surface 15 by means of a web 17, which appears from the sectional view in FIG. 3. It is thus also possible to use materials for the running surface 14 that show only a weak or no tendency to adhere to the material of the carrying element 13. The known PTFE materials and the like shall be mentioned here as examples only.

The extrusion coating of the carrying element 13, which extrusion coating forms the elastic sealing element 14, has essentially three functional projections or lips 18, 19, 20 in the embodiment being shown. These include the dynamic or sliding sealing surface 18, which slides on the support ring 21 connected to the outer bush 5, and the static sealing surface 19, which is arranged on the rear side of the carrying element 13 and guarantees sealing against the housing shells or bearing blocks 2, 3 (not shown here) of the central joint 1, see FIG. 2. Furthermore, the elastic sealing element 14 has another sealing lip 20, which is arranged on its outer circumference and forms an additional splash guard 20 for the highly stressed sliding sealing surface 18 located further inside.

On its upper radial plane relative to the drawing, the support ring 21 pressed onto the outer bush 5 forms the stop face 22 both for the sliding or dynamic seal 18 of the elastic sealing element 14 and for the running surface 15, which forms the extensively rigid axial bearing of the outer bush 5 relative to the inner bush 10. The separate seaport ring 21, separated from the outer bush 5, is advantageous because it may be manufactured, for example, from a material other than that of the outer bush 5 itself, and this material can be optimally adapted to the requirements of the sliding seal 18 or the axial bearing 15. Furthermore, the mounting of the central joint 1 is thus also facilitated, and better bearing tolerances can be achieved, for example, by the support rings 21 for the bearing arrangement 4 being arranged on the outer bush 5 only after the outer bush 5 and the coupler 6 have been welded together.

According to the views in FIG. 3 and FIG. 4, another static seal 23 is arranged in the area located axially between the bearing element 11 and the sealing module 12 or the carrying element 13, just as in the other exemplary embodiment according to FIGS. 5 through 7. The static seal 23 may be arranged either in the form of an annular sealing element 23 between the bearing element 11 and the carrying element 13. However, it may also be formed, for example, in the form of an annular shoulder 23, which is made in one piece with the bearing element 11 itself and is pressed onto the carrying element 13 during the mounting of the bearing arrangement 4.

The static seal 23 prevents contaminants that may have penetrated in the area of the pressed connection between the carrying element 13 and the inner bush 10 from being able to be pushed forward into the area of the bearing surface between the inner bush 10, on the one hand, and the bearing element 11 and the outer bush 5, on the other hand. Additional sliding sealing lips 24, which may be made especially in one piece with the bearing element 11, likewise serve the purpose of protecting the bearing surface between the inner bush 10, on the one hand, and the bearing element 11 and the outer bush 5, on the other hand.

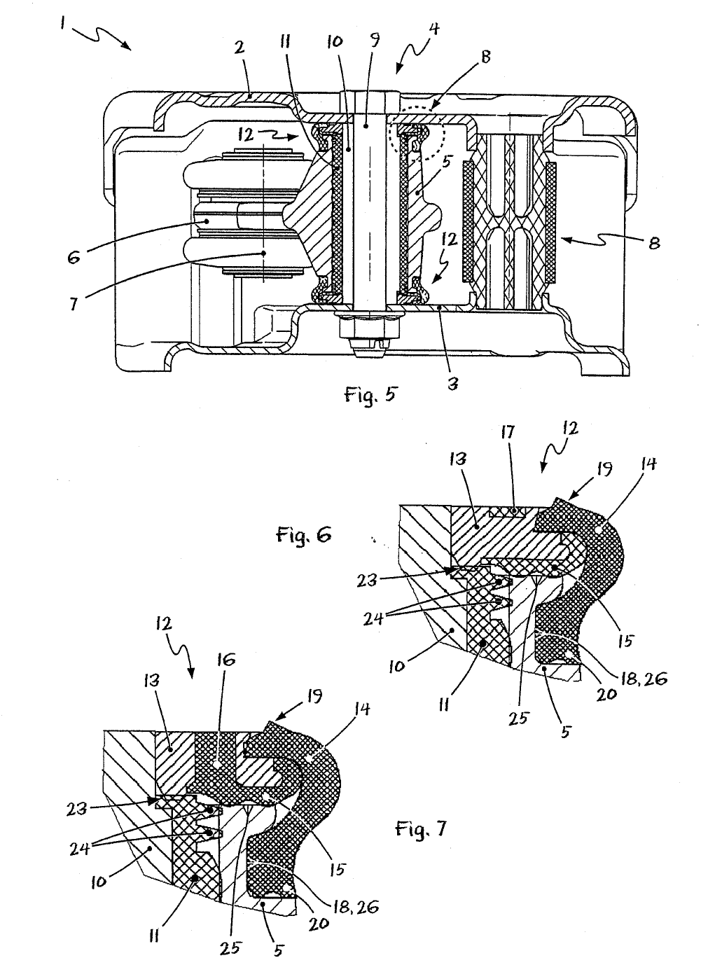

In a sectional view corresponding to FIG. 2, FIG. 5 shows a central joint with another embodiment of a bearing arrangement 4 according to the present invention, whereas FIG. 6 and FIG. 7 show the detail marked by the letter “B” from the view in FIG. 5 in an enlarged, cut-away sectional view.

The embodiment according to FIGS. 5 through 7 differs from the embodiment according to FIGS. 2 through 4 primarily by the shape and the arrangement of the elastic sealing element 14 as well as by the absence of the support ring 21 in the embodiment according to FIGS. 2 through 4.

Instead of the support ring 21, the front surface 25 of the outer bush 5 itself forms the stop face 25 for the running surface 15 of the sealing module 12 in the embodiment according to FIGS. 5 through 7. The sealing module 12 itself again comprises an annular carrying element 13, a running surface 15 extrusion-coated around the carrying element 13 in recesses 16 and webs 17, reaching through, as well as an elastic sealing element 14. The sealing element 14 is in turn rigidly connected to the carrying element 13 in the area of the static sealing surface 19, while it forms the dynamic sealing surface 18, sliding in an annular groove 26 on the outer side of the outer bush.

A lip each forming the static seal 19 is pressed onto the sheet metal housing shells or bearing blocks 2, 3 of the central joint 1 and additionally fixed relative to the bearing blocks 2, 3 as well as the stationary inner bush 10 during the mounting of the bearing arrangement 4 or the central joint 1 according to FIG. 5 and FIG. 2. On the whole, complete encapsulation of the bearing 4 for the coupler 6 of the central joint 1 and thus reliable protection of this highly stressed component are achieved.

It becomes clear as a result that the present invention makes it possible, in particular, to design the bearing arrangement, for example, for the central joint of a Watt's linkage, as well as the sealing thereof in a completely modular form, which leads to corresponding advantages in terms of manufacture, stocking, mounting and maintenance of the bearing arrangement. Furthermore, it is possible to use undivided, continuous bearing bushes thanks to the present invention, which likewise increases [sic-simplifies?-Tr.Ed.] the mounting and, moreover, the loadability and the service life of the bearing arrangement according to the present invention compared to the state of the art. The bearing arrangement according to the present invention has, furthermore, especially good sealing against environmental effects as well as an exact and smooth-running response behavior. Finally, the axial rigidity and the radial rigidity of the bearing arrangement can also be dimensioned independently from one another thanks to the present invention, which entails decisive advantages for highly stressed mounting sites such as the compact central joint in question.

Thus, the present invention makes an essential contribution to the economical production of highly stressable bearing arrangements for Watt's linkages, stabilizers, wheel suspensions and the like. While specific embodiments of the invention have been shown and described in detail to illustrate the application of the principles of the invention, it will be understood that the invention may be embodied otherwise without departing from such principles.

1. A bearing arrangement comprising:
an inner bush;
an outer bush, said inner bush and said outer bush being rotationally mobile in relation to one another by means of a common bearing surface and with a front-side bearing gap between said inner bush and said outer bush; and
a sealing arrangement, which surrounds the front-side bearing gap between said inner bush and said outer bush and seals same off from the environment, said sealing arrangement comprising an elastic sealing element with static as well as dynamic sealing surfaces, said sealing arrangement being designed as a sealing module, which can be connected to said inner bush, said sealing module comprising a running surface means for the axial mounting of said outer bush.

2. A bearing arrangement in accordance with claim 1, wherein said sealing module comprises a carrying element, said running surface means and said carrying element consisting of different materials.

3. A bearing arrangement in accordance with claim 1, wherein said elastic sealing element is a one-piece element.

4. A bearing arrangement in accordance with claim 1, wherein the static seal comprises a sealing collar arranged between said sealing module and a bearing block to which the bearing arrangement is mounted.

5. A bearing arrangement in accordance with claim 1, wherein said running surface means extends behind said carrying element and engages said carrying element in a positive-locking manner.

6. A bearing arrangement in accordance with claim 1, wherein said sealing module is shrunk or pressed onto the axial end of said inner bush.

7. A bearing arrangement in accordance with claim 1, wherein said outer bush has a support ring with an axial stop plane.

8. A bearing arrangement in accordance with claim 7, wherein said support ring is shrunk or pressed onto the axial end of said outer bush.

9. A bearing arrangement in accordance with claim 7, wherein said dynamic sealing surface and said running surface means come into contact at said stop plane.

10. A bearing arrangement in accordance with claim 1, wherein said dynamic sealing surface, surrounding the front side of said outer bush, comes into contact with a outer circumference of said outer bush.

11. A bearing arrangement in accordance with claim 1, wherein the bearing surface is formed on the side of the inner bush by a bearing element consisting of a polymer.

12. A bearing arrangement in accordance with claim 11, wherein said bearing element is in the form of an extrusion-coated plastic on said inner bush.

13. A bearing arrangement in accordance with claim 11, wherein said bearing element consists of a thermoplastic polyurethane.

14. A bearing arrangement in accordance with claim 1, wherein said bearing element comprises at least one additional dynamic seal for protecting the bearing surface.

15. A bearing arrangement in accordance with claim 1, wherein said static seal comprises a circumferential joint arranged between said bearing element and said sealing module.

16. A bearing arrangement in accordance with claim 1, wherein said sealing module comprises an additional splash guard.

17. A bearing arrangement in accordance with claim 16, wherein said additional splash guard is made in one piece with said elastic sealing element.

18. A bearing arrangement in accordance with claim 1, wherein said elastic sealing element consists of nitrile-butadiene rubber.

19. A bearing arrangement in accordance with claim 1, wherein said bearing arrangement comprises a sealing module and/or a support ring each at both ends of said inner bush and said outer bush.

20. A bearing arrangement comprising:
a first side bearing connection part;
a second side bearing connection part;
an inner bush fixed rotationally to said first side bearing connection part and said second side bearing connection part;
an outer bush, said inner bush and said outer bush being rotationally mobile in relation to one another by means of a common bearing surface and with a side bearing gap between said inner bush and said outer bush;
a sealing arrangement surrounding said side bearing gap between said inner bush and said outer bush and sealing off said bearing gap between said inner bush and said outer bush from the environment, said sealing arrangement comprising a sealing module connected to said inner bush with an elastic sealing element with a static sealing surface and a dynamic sealing surface, and a running surface means for an axial mounting of said outer bush relative to said inner bush and said sealing module.
